(19) United States
(12) Patent Application Publication
(10) Pub. No.: US 2012/0128952 A1
(43) Pub. Date: May 24, 2012

(54) GLASS FILM LAMINATE

(76) Inventors: Yoshiharu MIWA, Shiga (JP); Hiroshi Takimoto, Otsu-shi (JP); Hiroyuki Uchida, Otsu-shi (JP)

(21) Appl. No.: 13/118,889

(22) Filed: May 31, 2011

(30) Foreign Application Priority Data
Jun. 2, 2010 (JP) 2010-127317
Jun. 25, 2010 (JP) 2010-144372

(51) Int. Cl. B32B 17/10

(52) U.S. Cl. 428/215

(57) ABSTRACT

The glass film laminate comprises a laminate structure of three or more layers, which includes a layer formed of a glass film and a transparent resin layer. The both outermost layers of the glass film laminate are formed of the glass film. The glass film has a thickness of 300 μm or less, and the transparent resin layer has a thickness larger than that of the glass film.

### TECHNICAL FIELD

The present invention relates to a glass material used for a building, an automobile, an agricultural greenhouse, a glass substrate for a device, as exemplified by a flat panel display such as a liquid crystal display or an OLED display, a solar cell, a lithium ion battery, a digital signage, a touch panel, electronic paper, a cover glass for a device, as exemplified by an OLED lighting device, a package for medicinal products, and the like. More specifically, the present invention relates a glass material which is excellent in weather resistance and is lightweight.

### BACKGROUND ART

A glass sheet is excellent in weather resistance, chemical resistance, and abrasion resistance, and is excellent in lighting property because of its good transparency, and hence the glass sheet is widely used for window or skylight materials in general buildings, high-rise buildings, and the like, a covering material for an agricultural greenhouse, and window materials for vehicles such as automobiles and electric trains and the like.

However, glass is a brittle material, and hence has a problem in that glass is vulnerable to a physical impact and easily breaks. It is known that, when a flying object or a high-speed object hits a glass sheet, the glass sheet easily breaks, and that glass also easily breaks due to a thermal impact.

In order to solve this problem, many proposals have been made on a laminate in which a transparent resin material is laminated on a glass sheet. The transparent resin material is excellent in lighting property because of its good transparency, in the same way as glass of an inorganic material. Besides, the transparent resin material has an advantage of having higher physical impact resistance than glass, but has a disadvantage of being inferior in chemical resistance, weather resistance, and abrasion resistance to glass. For example, Patent Document 1 below proposes a laminated glass (glass laminate) formed by laminating sequentially glass/polyvinyl butyral/polycarbonate/polyvinyl butyral/glass. In Patent Document 1, a glass sheet which is vulnerable to a physical impact is supported by a transparent resin material, so as to prevent the glass sheet from breakage and scatter, and also the transparent resin material is sandwiched by the glass sheets which are excellent in weather resistance and abrasion resistance, so as to prevent the transparent resin material from being exposed to an external environment. Thus, the disadvantages of the glass sheet and the transparent resin material are complemented by the corresponding advantages.

### CITATION LIST

### Patent Document

Patent Document 1: JP 06-915 A

### SUMMARY OF INVENTION

### Technical Problem

However, glass has a density of about 2.2 to 2.6 g/cm³ and is a substance which is liable to be very heavy. Since a glass sheet used in buildings or the like has generally a thickness of 2 to 10 mm, when the size of the glass sheet becomes large, the weight thereof becomes great. If the weight of glass is greater, there exists a problem in that, when a glass sheet is used for a window material in a high-rise building, a covering material for an agricultural greenhouse, or the like, high-rank materials for posts, beams, furring strips, and purlins must be used from the viewpoint of quake resistance, leading to higher cost. Further, when a glass sheet is used for a window material for a vehicle such as an automobile, if the weight of the glass sheet is greater, the fuel efficiency of the vehicle deteriorates, leading to the increase of the amount of carbon dioxide, thereby possibly causing some environmental problems.

On the other hand, in Patent document 1 as mentioned above, as if apart of the glass sheet was replaced with polycarbonate sheet, and hence the total weight of the laminate is smaller than that of the glass sheet if both have the same size.

However, in examples in Patent Document 1, a glass sheet having a thickness of 0.5 mm or more is used for a laminated glass. Thus, in the case of a laminated glass using two glass sheets, the total thickness of the glass sheets in the laminated glass is 1 mm. For example, given that a 2-mm laminated glass is used as a substitute for a 2-mm glass sheet, the total thickness of the glass sheets will account for 1 mm which is the half of the laminated glass, which cannot lead a sufficient reduction in weight of the laminated glass.

An object of the present invention is to solve such problems of the prior art as described above, thereby to accomplish reduction in weight of a glass laminate serving as a substitute for a glass sheet.

### Solution to Problem

The present invention provides a glass film laminate, comprising a laminate structure of three or more layers, which includes a layer formed of a glass film and a transparent resin layer, wherein both outermost layers of the glass film laminate are formed of the glass film, the glass film having a thickness of 300 μm or less, and the transparent resin layer having a thickness larger than that of the glass film. Here, the glass film constituting the glass film laminate of the present invention includes a glass film, on one surface or both surfaces of which a desired functional film is formed.

The glass film laminate of the present invention preferably comprises the laminate structure of three layers, which is constituted by the both outermost layers of the glass film and the transparent resin layer interposed between the both outermost layers of the glass film.

In the glass film laminate of the present invention, the transparent resin layer preferably has a thickness ten times or more than that of the glass film.

In the glass film laminate of the present invention, the glass film is preferably made of alkali-free glass.

In the glass film laminate of the present invention, the glass film is preferably manufactured by an overflow down-draw method.

In the glass film laminate of the present invention, the glass film preferably has a Young's modulus of 50 GPa or more.

In the glass film laminate of the present invention, the glass film preferably has a Vickers hardness of 400 or more.

### Advantageous Effects of Invention

In the glass film laminate of the present invention, the outermost layers are formed of the glass film, and hence the transparent resin layer can be prevented from being exposed to an external environment. In addition, the thickness of the glass film is 300 μm or less and the thickness of the transparent resin layer is larger than that of the glass film, and hence it is possible to decrease as much as possible the total thickness of the glass films in the thickness of the glass film laminate and to increase the thickness of the transparent resin layer. As a result, a glass film laminate having a reduced weight can be provided.

When the glass film laminate of the present invention comprises the laminate structure of three layers, which is constituted by the both outermost layers of the glass film and the transparent resin layer interposed between the both outermost layers of the glass film, it is possible to minimize the amount of usage of glass films having a high density. As a result, the weight of the whole glass film laminate can be reduced more effectively.

When the transparent resin layer has a thickness ten times or more than that of the glass film, in the glass film laminate of the present invention, the ratio of the transparent resin layer in the glass film laminate increases, and hence the weight of the whole glass film laminate can be further reduced. Thereby, the weight of the glass film laminate can be reduced more effectively.

When the glass film is made of alkali-free glass, in the glass film laminate of the present invention, the weather resistance and chemical resistance of the glass film improve, and hence it is possible to provide a glass film laminate suitable for longer time use.

When the glass film is manufactured by an overflow down-draw method, in the glass film laminate of the present invention, a glass film having a thickness of 300 μm or less can be manufactured in bulk at low cost. The glass film manufactured by the overflow down-draw method does not need adjustment of its thickness by polishing, grinding, chemical etching, or the like.

When the glass film has a Young's modulus of 50 GPa or more, in the glass film laminate of the present invention, a glass film laminate having a desired rigidity can be provided even if the thickness of the glass film is made thin for accomplishing reduction in weight.

When the glass film has a Vickers hardness of 400 N/mm² or more, in the glass film laminate of the present invention, a glass film laminate having a higher abrasion resistance can be provided.

### BRIEF DESCRIPTION OF DRAWINGS

FIG. 1(a) is a cross-sectional view of a glass film laminate according to the present invention, which has a three-layer structure.

FIG. 1(b) is a cross-sectional view of a glass film laminate according to the present invention, which has a five-layer structure.

FIG. 2 is an explanatory diagram of an apparatus for producing a glass film.

FIG. 3 is a cross-sectional view showing a glass film laminate using a glass film on one surface of which film formation is performed.

### DESCRIPTION OF EMBODIMENTS

Hereinafter, preferred embodiments of a glass film laminate according to the present invention are described with reference to the drawings.

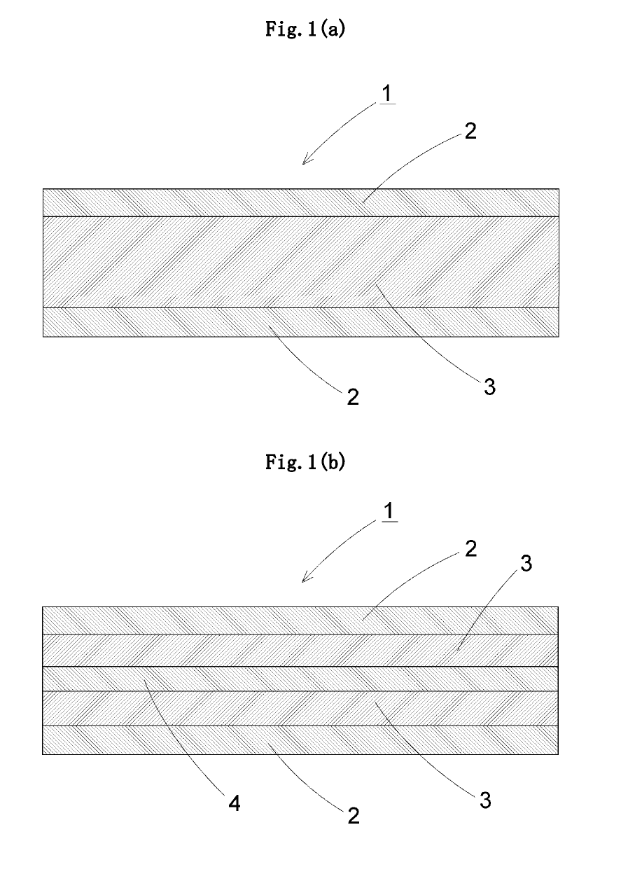

As shown in FIGS. 1(a) and 1(b), a glass film laminate (1) according to the present invention is a laminate in which glass films (2) and (4) (FIG. 1(b)) and a transparent resin layer (3) are laminated. The both outermost layers are constituted by the glass films (2).

For the glass films (2) and (4), silicate glass is used, preferably, silica glass, borosilicate glass, soda lime glass, or aluminosilicate glass is used, more preferably, alkali-free glass is used. Glass is typically excellent in weather resistance. However, in the case of the glass films (2) and (4) containing an alkali component, cation removal occurs on the surfaces of the glass films during prolonged use of the glass films in the state of being exposed to an external environment, leading to occurrence of a so-called too-abundant soda phenomenon, which may result in a coarse structure. Accordingly, the transparency of the glass films (2) and (4) may deteriorate. Note that the alkali-free glass is glass substantially free of an alkali component (alkali metal oxide), and specifically, glass that contains the alkali component at a weight ratio of 1000 ppm or less. The weight ratio of the alkali component in the present invention is preferably 500 ppm or less, more preferably 300 ppm or less.

A glass material of the same kind or different kinds may be used for the glass films (2) and (4). For example, when the glass film laminate (1) is used for windows and the like for a building, alkali-free glass having much better weather resistance may be used for the glass film (2) positioned at the side exposed to an external environment, and soda lime glass or the like may be used for the glass film (2) positioned at the side facing an internal environment such as an indoor environment or for the glass film (4) laminated as an inner layer sandwiched by the transparent resin layers (3).

As shown in FIGS. 1(a) and 1(b), the both outermost layers of the glass film laminate (1) are each constituted by the glass film (2). As a result, the transparent resin layer (3) poor in weather resistance and abrasion resistance can be properly protected. Note that the glass film laminate (1) is not limited to the structure shown in FIG. 1(a), and may have such a structure as shown in FIG. 1(b), in which the glass film (4) is laminated as an inner layer sandwiched by the transparent resin layers (3).

The thickness of each of the glass films (2) and (4) is 300 μm or less, and the thickness of the transparent resin layer (3) is larger than that of each of the glass films (2) and (4). As a result, the ratio of the glass films (2) and (4) in the glass film laminate (1) decreases, thereby the reduction in weight of the glass film laminate (1) can be accomplished. When the thickness of each of the glass films (2) and (4) is more than 300 μm, the weight of the glass films (2) and (4) in the glass film laminate (1) increases, and hence it is difficult to accomplish the reduction in weight of the glass film laminate (1). Further, when the thickness of each of the glass films (2) and (4) is larger than that of the transparent resin layer (3), the thickness of the transparent resin layer (3) becomes too small to support the glass films (2) and (4) effectively. On the other hand, when the thickness of each of the glass films (2) and (4) is 300 μm or less, the glass films (2) and (4) are rich in flexibility, and hence the glass films (2) and (4) themselves cannot maintain their rigidity. In this case, the glass films (2) and (4) need to be supported by the transparent resin layer (3), and hence the thickness of the transparent resin layer (3) needs to be larger than that of each of the glass films (2) and (4).

The thickness of each of the glass films (2) and (4) is preferably 20 μm to 200 μm, most preferably 50 μm to 100 μm. With this, the thickness of each of the glass films (2) and (4) is made thinner, thus being able to reduce the weight of the glass film laminate (1) more effectively. When the thickness of each of the glass films (2) and (4) is less than 20 μm, the strength of the glass films (2) and (4) is liable to be insufficient, and hence, when a flying object or the like hits the glass film laminate (1), the glass films (2) and (4) tend to break. Note that in this case, the glass films (2) and (4) do not scatter after breaking because the transparent resin layer (3) supports the glass films (2) and (4).

The thicknesses of the glass films (2) and (4) may be identical to or different from each other. For example, when the glass film laminate (1) is used for windows and the like for a building, the thickness of the glass film (2) positioned at the side exposed to an external environment maybe set to a larger value (for example, 100 μm), and the thickness of the glass film (2) positioned at the side facing an internal environment such as an indoor environment and the thickness of the glass film (4) laminated as an inner layer sandwiched by the transparent resin layers (3) maybe set to a small value (for example, 50 μm).

The density of each of the glass films (2) and (4) is preferably lower. With this, the reduction in weight of the glass films (2) and (4) can be accomplished, resulting in being able to accomplish the reduction in weight of the glass film laminate (1). Specifically, the density of each of the glass films (2) and (4) is preferably 2.6 g/cm³ or less, more preferably 2.5 g/cm³ or less.

The Young's modulus of each of the glass films (2) and (4) is preferably higher. With this, even when the thickness of each of the glass films (2) and (4) is made as thin as 300 μm or less, the glass films become hard to bend under their own weight. The supporting function of the transparent resin layer (3) for supporting the glass films (2) and (4) can be reduced, and hence the glass film laminate (1) having a desired rigidity can be provided by using thinner glass films (2) and (4), thus being able to reduce the weight of the whole glass film laminate (1). The Young's modulus of each of the glass films (2) and (4) is preferably 50 GPa or more, more preferably 60 GPa or more, most preferably 70 GPa or more. In particular, when the Young's modulus of each of the glass films (2) and (4) is 70 GPa or more, the glass films (2) and (4) themselves can have a certain degree of rigidity. Thus, the glass film laminate (1) including such the glass films (2) and (4) can be particularly suitably used for a member that requires rigidity as well as reduced weight, such as a window for an automobile (in particular, an opening and closing side glass with no supporting frame body).

The Vickers hardness of each of the glass films (2) and (4) is preferably higher. With this, a glass film laminate having higher abrasion resistance can be provided. The Vickers hardness of each of the glass films (2) and (4) is preferably 400 or more, more preferably 500 or more, most preferably 550 or more. The glass film laminate (1) including the glass films each having a Vickers hardness of 400 or more can be particularly suitably used for a member that requires abrasion resistance as well as reduced weight, such as a touch panel portion in a portable electronic device.

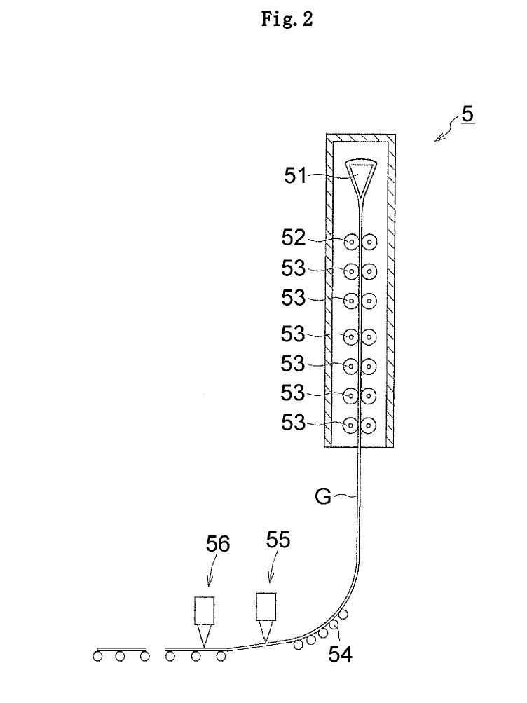

The glass films (2) and (4) to be used in the present invention are preferably formed by an overflow down-draw method as shown in FIG. 2. With this, a glass film having a thickness of 300 μm or less can be manufactured in bulk at low cost. The glass film manufactured by the overflow down-draw method does not need adjustment of its thickness by polishing, grinding, chemical etching, or the like. Further, the overflow down-draw method is a forming method in which both surfaces of a glass sheet are not brought into contact with a forming member during a forming process, and hence the both surfaces (translucent surfaces) of the obtained glass sheet are fire-finished surfaces, and high surface-quality may be obtained for the glass sheet without polishing work. As a result, an adhesive force between each of the glass films (2) and (4) and the transparent resin layer (3) can be improved, thereby being able to perform their lamination more accurately and precisely.

A forming apparatus (5) internally includes a trough (51) having an outer surface with a wedge shape in the cross section, in which glass (molten glass) melted in a melting furnace (not shown) is supplied into the trough (51) to overflows from the top portion of the trough (51). The overflowing molten glass then flows along the both sides of the trough (51) having the wedge shape in the cross section to join at the lower end of the trough (51), thereby forming of the molten glass into a glass film ribbon (G) is started. The glass film ribbon (G) immediately after joining at the lower end of the trough (51) is drawn downward by cooling rollers (52), while its contraction in the width direction is being restricted, to become thin to a predetermined thickness. Next, the glass film ribbon (G) getting to the predetermined thickness is delivered by rollers (53) to be annealed in an annealing furnace (annealer) for removing the heat strain of the glass film ribbon (G) and then cooling it sufficiently to about a room temperature. The glass film ribbon (G) that has passed the annealing furnace changes the direction of movement thereof from the vertical direction to the horizontal direction with curving aid rollers (54). Then, a longitudinal direction cutting apparatus (55) cuts unnecessary portions at the both end in the width direction of the glass film ribbon (G) (portions with which the cooling rollers (52), the rollers (53), and the like have come into contact). After that, the resultant glass film ribbon (G) is cut with a width direction cutting apparatus (56) at each predetermined interval. Thus, the glass films (2) and (4) to be used in the present invention are obtained. Note that the glass films (2) and (4) may be manufactured by cutting the glass film ribbon (G) in the width direction with the width direction cutting apparatus (56) and then cutting and removing the unnecessary portions of the resultant glass sheet with the longitudinal direction cutting apparatus (55). In addition, the forming apparatus (5) described above employs a single sheet processing for manufacturing the glass films (2) and (4), however, the manufacturing method is not limited thereto. The glass films (2) and (4) may be manufactured by such a manner in that the glass film ribbon (G), without cutting it in the width direction while cutting the unnecessary portions thereof with the longitudinal direction cutting apparatus (55), is rolled up in a roll shape via a inserting paper to form a glass roll, and then the glass film ribbon (G) is rolled out from the glass roll to be cut to have predetermined dimensions in the step of performing lamination with the transparent resin layer.

The transparent resin layer (3) is not particularly limited as long as it is a transparent resin. It is possible to use, for example, polyethylene, polyvinyl chloride, polyethylene terephthalate, polyvinylidene chloride, polypropylene, polyvinyl alcohol, a polyester, polystyrene, polyacrylonitrile, an ethylene-vinyl acetate copolymer, an ethylene-vinyl alcohol copolymer, an ethylene-methacrylate copolymer, an acrylic, or a polycarbonate. It is particularly preferred that an acrylic or a polycarbonate be used because they have excellent transparency.

The thickness of the transparent resin layer (3) can be arbitrarily set or selected depending on the thickness of the glass films (2) and (4) to be used, the target thickness of the glass film laminate (1), and the like. When the glass film laminate (1) is used for windows and the like in a building, the glass film laminate (1) preferably do not bend, and hence it is preferred that the transparent resin layer (3) have a certain degree of thickness enough to be able to support the glass films (2) and (4).

The thickness of the transparent resin layer (3) is preferably equal to or larger than the total thickness of the glass films (2) and (4), more preferably three times or more than the total thickness of the glass films (2) and (4). With this, the ratio of the transparent resin layer (3) in the glass film laminate (1) increases, and hence the weight of the whole glass film laminate (1) can be further reduced, thus being able to accomplish more effectively the reduction in weight of the glass film laminate (1). When the glass films (2) and (4) have different thicknesses to each other, the thickness of the transparent resin layer (3) is preferably three times or more than the thickness of the glass film having the largest thickness. The thickness of the transparent resin layer (3) is preferably ten times or more than the thickness of each of the glass films (2) and (4), most preferably 20 times or more.

A method of laminating the transparent resin layer (3) between the glass films (2) and (4) is not particularly limited, and any known method can be arbitrarily selected and used. For example, the glass films and the transparent resin layer may be adhered by using a pressure-sensitive adhesive sheet, or may be adhered by using an intermediate film such as an ultraviolet curing resin, a PVB resin, an EVA resin, or an ionoplast resin. When an adhesive is used, preferred is an adhesive showing a transparent state after adhesion is completed. Alternatively, the glass film laminate (1) may be manufactured by heat-sealing the transparent resin layer (3) between the glass films (2) and (4). Besides, it is also possible to manufacture the glass film laminate (1) by directly forming a transparent resin between the glass films (2) and (4).

As shown in FIG. 1(a), the glass film laminate (1) according to the present invention preferably has a three-layer structure constituted by a glass film/a transparent resin layer/a glass film. As a result, it is possible to minimize the amount of usage of glass films having a high density, because a glass film (4) is not laminated in the middle of the structure. Consequently, the weight of the whole glass film laminate can be reduced more effectively.

In FIG. 1(b), the glass films (2) and (4) and the transparent resin layers (3) are laminated alternately. However, the glass film laminate (1) is not limited to this configuration, and. For example, two transparent resin layers (3) may be consecutively laminated. In a configuration in which two or more transparent resin layers (3) are laminated, transparent resin layers (3) of different kinds may be used.

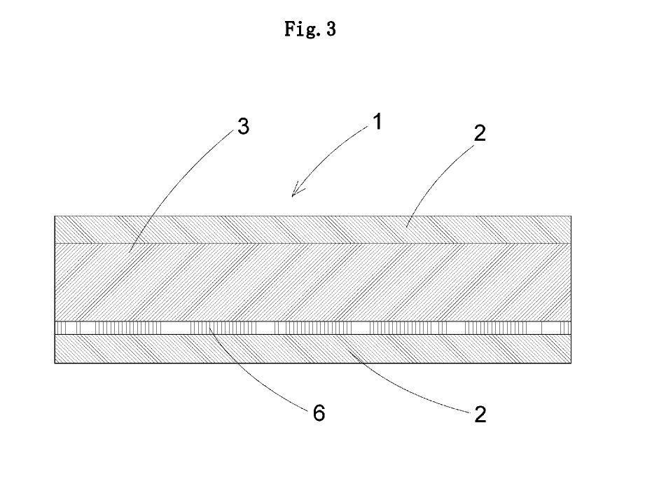

FIG. 3 is a view showing another embodiment of the glass film laminate (1) according to the present invention. In FIG. 3, a glass film laminate (1) is manufactured by such a manner in that a thin film layer (6) is formed on a surface of a glass film (2) and sandwiched with the glass film (2) and a transparent resin layer (3) so that the thin film layer (6) is brought into contact with a surface of the transparent resin layer (3). As a result, the thin film layer (6) is positioned inside of the glass film laminate (1), and hence it is possible to prevent the thin film layer (6) from the degradation in function as a functional film, which is caused in the case of the thin film layer (6) being exposed to an external environment. The thin film layer (6) maybe formed on not only one surface of the glass film (2) but also both surfaces thereof. Further, in the embodiment of the glass film laminate (1) shown in FIG. 1(b), film formation may be performed on only the glass film (4) or both the glass film (2) and the glass film (4).

It is possible to use a well-known method such as a sputtering method, a CVD method, a PVD method, a resistance heating method, or an ion plating method as a film formation method of forming the thin film layer (6). The glass films (2) and (4) each has as very thin a thickness as 300 μm or less, and hence easily raises their temperature by heating. Thus, in particular, film formation requiring heating of a substrate is easily performed. That is, there is the advantage in that the necessary heat capacity during film formation becomes decreased, when the glass film laminate (1) having a thickness of 2 mm is manufactured by forming the film on the glass film having a thickness of 300 μm and then making the resultant glass film adhere to the transparent resin layer (3), rather than when a film is formed on a glass sheet having a thickness of 2 mm.

It is possible to select arbitrarily, as the thin film layer (6) formed on the glass films (2) and (4), from a metal film, a transparent conductive film, an ultraviolet cutting film, an infrared ray cutting film, an insulating film, a magnetic film, and the like, depending on functions that should be imparted to the glass film laminate (1) and target applications thereof. For example, when the glass film laminate (1) is used as a substitute for a window glass for an automobile, a function as a defogger heater can be imparted to the glass film laminate (1) by forming a metal film or a transparent conductive film on the glass film (2), followed by its connection to electrodes. Further, when an infrared ray cutting film or an ultraviolet cutting film is formed on the glass film (2), the resultant glass film laminate (1) can be used for the prevention of temperature elevation in a car interior, the prevention of the degradation of in-house facilities, and the like. Further, it is also possible to form thin film layers (6) of different kinds on each of the both glass films (2) and the glass film (4), such as forming an infrared ray cutting film on one of the glass films (2) and forming an ultraviolet cutting film on the other glass film (2) or the glass film (4).

### EXAMPLES

Hereinafter, the glass film laminate of the present invention is described in detail based on examples, but the present invention is not limited to those examples.

### Example 1

Prepared were two glass films each having a rectangular shape measuring 300 mm long by 300 mm wide by 100 μm thick. Used as each of the glass films was alkali-free glass manufactured by Nippon Electric Glass Co., Ltd. (product name: OA-10G, thermal expansion coefficient at 30 to 380° C.: 38×10⁻⁷/° C.) which was formed into a glass film by an overflow down-draw method and used as it was without polishing. Prepared as a transparent resin layer was a polycarbonate sheet having a rectangular shape measuring 300 mm long by 300 mm wide by 4 mm thick. The polycarbonate sheet was interposed between the two glass films and adhered there to by pressure-sensitive adhesive sheets, thereby manufacturing a glass film laminate having a three-layer structure. The measurement of the weight of the resultant glass film laminate showed 477 g.

### Comparative Example 1

Prepared was a glass sheet having a rectangular shape measuring 300 mm long by 300 mm wide by 4 mm thick. The material of glass is the same as that in Example 1. The measurement of the weight of the glass sheet showed 900 g.

### Example 2

Prepared were two glass films each having a rectangular shape measuring 100 mm long by 100 mm wide by 100 mm thick. The material of glass and the manufacturing method are the same as those in Example 1 described above. Prepared as a transparent resin layer was a polycarbonate sheet having a rectangular shape measuring 100 mm long by 100 mm wide by 10 mm thick. The polycarbonate sheet was interposed between the two glass films and adhered thereto by irradiating a UV curable resin interposed therebetween, thereby manufacturing a glass film laminate having a three-layer structure. The measurement of the weight of the resultant glass film laminate showed 125 g.

### Comparative Example 2

Prepared was a glass sheet having a rectangular shape measuring 100 mm long by 100 mm wide by 10 mm thick. The material of glass is the same as that in Example 1. The measurement of the weight of the glass sheet showed 250 g.

### INDUSTRIAL APPLICABILITY

The glass film laminate according to the present invention can be suitably used for window materials in general buildings, high-rise buildings, and the like, a skylight window for a roof, a covering material for an agricultural greenhouse, window materials for vehicles and the like, such as automobiles and electric trains, and substrates, cover glasses, and touch panels for electronic devices.

### REFERENCE SIGNS LIST

1 glass film laminate
2 glass film
3 transparent resin layer
4 glass film
6 thin film layer

1. A glass film laminate, comprising a laminate structure of three or more layers, which includes a layer formed of a glass film and a transparent resin layer, wherein:
both outermost layers of the glass film laminate are formed of the glass film;
the glass film has a thickness of 300μm or less; and
the transparent resin layer has a thickness larger than that of the glass film.

2. The glass film laminate according to claim 1, wherein the glass film laminate comprises the laminate structure of three layers, which is constituted by the both outermost layers of the glass film and the transparent resin layer interposed between the both outermost layers of the glass film.

3. The glass film laminate according to claim 1, wherein the transparent resin layer has a thickness ten times or more than that of the glass film.

4. The glass film laminate according to claim 1, wherein the glass film is made of alkali-free glass.

5. The glass film laminate according to claim 1, wherein the glass film is manufactured by an overflow down-draw method.

6. The glass film laminate according to claim 1, wherein the glass film has a Young's modulus of 50 GPa or more.

7. The glass film laminate according to claim 1, wherein the glass film has a Vickers hardness of 400 or more.
